(19) United States
(12) Patent Application Publication
(10) Pub. No.: US 2026/0239158 A1
(43) Pub. Date: Aug. 13, 2026

(54) MECHANISM FOR TRAFFIC DESCRIPTOR DETERMINATION FOR PERSONAL IOT NETWORK (PIN)

(71) Applicant: InterDigital Patent Holdings, Inc., Wilmington, DE (US)

(72) Inventors: Anuj Sethi, Ottawa (CA); Michael Starsinic, Newtown, PA (US); Saad Ahmad, Montreal (CA); Michel Roy, Candiac (CA); Debashish Purkayastha, Eagleville, PA (US)

(73) Assignee: InterDigital Patent Holdings, Inc., Wilmington, DE (US)

(21) Appl. No.: 19/156,590

(22) PCT Filed: Mar. 29, 2024
(86) PCT No.: PCT/US2024/022171

§ 371 Date: Aug. 14, 2025

Related U.S. Application Data
(60) Provisional application No. 63/455,786, filed on Mar. 30, 2023.

(51) Int. Cl. H04W 40/02

(52) U.S. Cl. CPC H04W 40/02

(57) ABSTRACT

A wireless transmit/receive unit (WTRU) may receive traffic descriptor determination rules that indicate an association of uplink personal internet of things network (PIN) traffic types to traffic descriptors. The WTRU may receive user equipment route selection policy (URSP) rules that indicate how to route uplink PIN traffic based on one or more PIN identifiers (IDs) and at least one of the traffic descriptors. The WTRU may receive uplink PIN traffic associated with a PIN ID of the one or more PIN IDs. The WTRU may determine a traffic descriptor for the received uplink PIN traffic based on the received traffic descriptor determination rules. The WTRU may select a protocol data unit (PDU) session for sending the uplink PIN traffic based on evaluation of the URSP rules using the PIN ID and the determined traffic descriptor.

### CROSS-REFERENCE TO RELATED APPLICATIONS

This application claims the benefit of U.S. Provisional Patent Application No. 63/455,786, filed on Mar. 30, 2023, the entire contents of which are incorporated herein by reference.

### BACKGROUND

A policy control function (PCF) may provide the wireless transmit receive unit (WTRU) with one or more WTRU policies. The PCF may provide each of the one or more WTRU policies using one or more WTRU policy sections. Each WTRU policy section may be identified by a user equipment policy section identifier (UPSI). User equipment route selection policy (URSP) rules may be a type of WTRU policy.

When a WTRU application initiates traffic, the WTRU may use URSP Rules to determine the desired characteristics for the PDU session that will carry the application traffic. Examples of characteristics of a PDU Session include but are not limited to: the data network name (DNN), single network slice selection assistance information (S-NSSAI), and/or a service and session continuity (SSC) mode associated with the protocol data unit (PDU) session.

The WTRU may use the URSP rule as a policy to determine how to route outgoing traffic. An established PDU session may route traffic. Outside a PDU, session, traffic may be offloaded to non-3GPP access. A ProSe Layer-3 UE-to-Network Relay outside a PDU session may route traffic. Traffic may trigger the establishment of a new PDU session.

Each URSP rule may consist of two parts. The first part of the URSP rule may be a traffic descriptor. The traffic descriptor may determine when the rule applies. A URSP rule may apply when every component in the traffic descriptor matches the corresponding information from the application. The second part of the URSP rule may be a list of route selection descriptors (RSD). The list of RSDs may contain one or more RSDs. The RSDs may be listed in priority order and/or describe the characteristics of a PDU session. The PDU session may carry the uplink application data. Characteristics of a PDU session may include a SSC mode, DNN, and/or S-NSSAI. The RSD may alternatively include a non-seamless offload indication. The non-seamless offload indication may indicate that the traffic may be sent via non-3GPP access (e.g., WiFi) and/or outside of any PDU session.

### SUMMARY

A wireless transmit/receive unit (WTRU) may receive traffic descriptor determination rules that indicate a mapping of uplink personal internet of things network (PIN) traffic types to traffic descriptors. The WTRU may receive user equipment route selection policy (URSP) rules that indicate how to route uplink PIN traffic based on one or more PIN identifiers (IDs) and at least one of the traffic descriptors. The WTRU may receive uplink PIN traffic associated with a PIN ID of the one or more PIN IDs. The WTRU may determine a traffic descriptor for the received uplink PIN traffic based on the received traffic descriptor determination rules. The WTRU may select a protocol data unit (PDU) session associated with the determined traffic descriptor for sending the received uplink PIN traffic based on evaluation of the URSP rules using the PIN ID and the determined traffic descriptor. The WTRU may send the uplink PIN traffic to the network via the selected PDU session.

The traffic descriptor determination rules may comprise an association between traffic identifiers and respective traffic descriptor values. An uplink PIN traffic type for the received uplink PIN traffic may be based on the PIN ID. The WTRU may evaluate the USRP rules to determine one or more PDU session characteristics. The PDU session for sending the uplink PIN traffic may be selected based on the determined one or more PDU session characteristics matching the PDU session. The uplink PIN traffic may originate from a PIN element (PINE) and/or an application hosted on the WTRU. The WTRU may determine that no established PDU sessions match the determined one or more PDU session characteristics. The WTRU may trigger establishment of the selected PDU session based on the determination that no established PDU sessions matching the determined one or more PDU session characteristics.

The URSP rules may be received from a PIN element with management capability (PEMC), the network, a PIN server, and/or an application hosted on the WTRU. The uplink PIN traffic types may comprise one or more of internet protocol multimedia subsystem (IMS), internet of things (IoT) sensor reading, and/or streaming media.

The traffic descriptors may comprise one or more of a connection capability, a PIN element (PINE) ID, a source internet protocol (IP) address, a source port number, a fully qualified domain name (FQDN), a data network name (DNN), a destination IP address, a destination port number, an operating system (OS) identifier, and/or an application identifier.

The WTRU may send a request to the network to establish the selected PDU session.

The uplink PIN traffic may be first uplink PIN traffic. The PIN ID may be a first PIN ID. The traffic descriptor may be a first traffic descriptor. The selected PDU session may be a first selected PDU session. The WTRU may receive second uplink PIN traffic associated with a second PIN ID of the one or more PIN IDs. The WTRU may determine a second traffic descriptor for the second uplink PIN traffic based on the received traffic descriptor determination rules. The WTRU may select a second protocol data unit (PDU) session for sending the second uplink PIN traffic based on evaluation of the URSP rules using the second PIN ID and the second traffic descriptor. The WTRU may send the second uplink PIN traffic to the network via the second selected PDU session.

One or more traffic rules (e.g., URSP) for the PIN may be extended with one or more additional parameters and/or the PIN ID to determine the PIN. The one or more additional parameters may include connection capabilities (e.g., internet protocol multimedia subsystem (IMS), multimedia subsystem (MMS), and/or internet connection), an application descriptor (e.g., Android identifier (OSId) and/or Android application identifier (OSAPPId)), and/or a DNN, etc.

One or more traffic descriptor determination rules for a PIN may be configured with the admin user via a graphic user interface (GUI), provided to PIN elements with gateway capability (PEGC) via PIN elements via management capability (PEMC), and/or directly configured in PEGC. The one or more traffic descriptor determination rules may include, but not be limited to: one or more PINE associations to connection capabilities; an application descriptor; a DNN; a PIN-ID, and/or application differentiation. These one or more traffic descriptor determination rules may be needed in case multiple applications are running on PINEs. The running of multiple applications may be achieved via mapping information on the port numbers with specific applications running on PINEs.

The network (e.g., a home policy control function (H-PCF)) via non-access stratum (NAS) signaling to the PEGC and/or PEMC may provide one or more traffic descriptor determination rules for the PIN.

The PIN server via the user plane (UP) to PEMC and/or PEGC may provide one or more traffic descriptor determination rules for the PIN (e.g., one or more PINE associations to connection capabilities; an application descriptor; a DNN; a PIN-ID, and/or application differentiation).

The network may provide one or more traffic rules as PIN specific URSP rules. The network may provide a list of UPSIs associated with PIN ID and/or public land mobile network identifier (PLMN ID). The UPSIs may map to the policy section comprising URSP rules.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram depicting an example personal Internet of Things (PIN) networks architecture.

FIG. 3 is a diagram depicting an example home automation PIN.

FIG. 4 is a diagram depicting an example wearable PIN.

FIG. 5 is a diagram depicting an example application layer support for personal internet of things (IoT) network (PINAPP) architecture.

FIG. 6 is a call flow depicting an example procedure for extension of traffic descriptor for PIN.

FIG. 7 is a call flow depicting an example procedure for PIN specific user equipment rule selection policy (URSP) rules.

FIG. 8 is a call flow depicting an example procedure for extension of traffic descriptor for PIN using PIN specific URSP rules.

### DETAILED DESCRIPTION

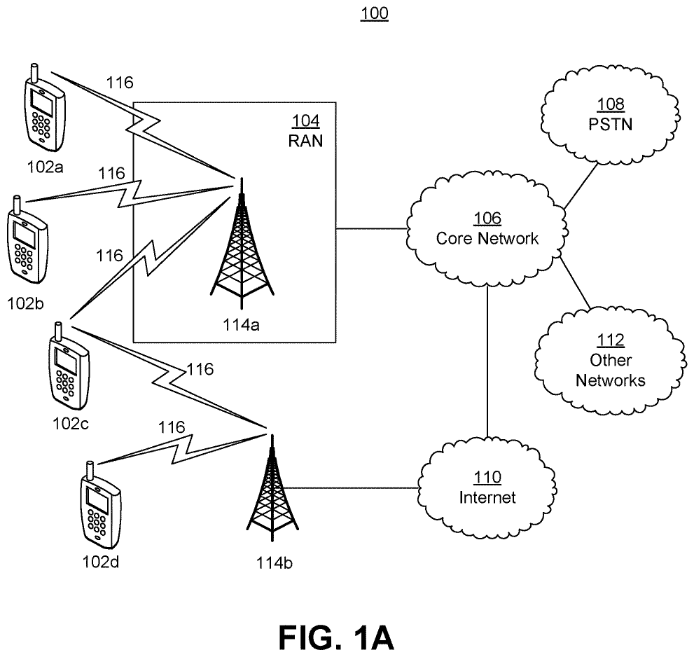

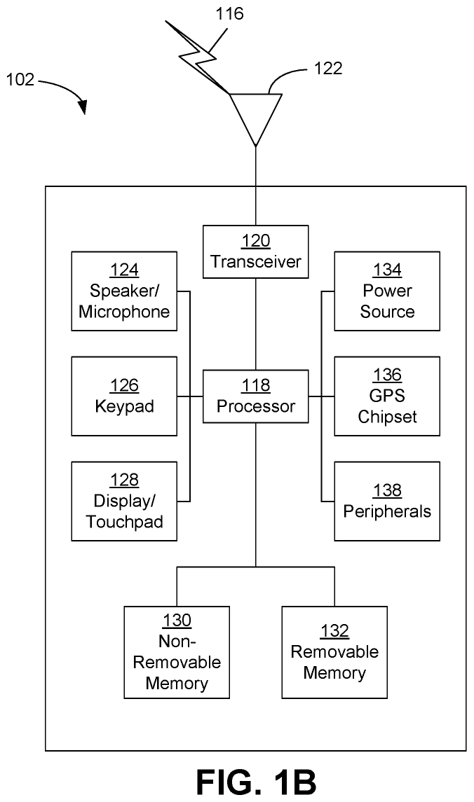

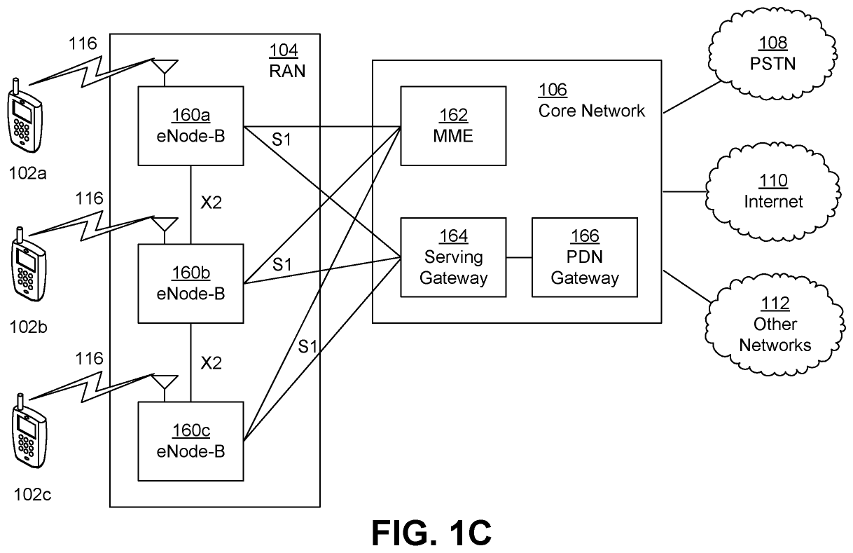

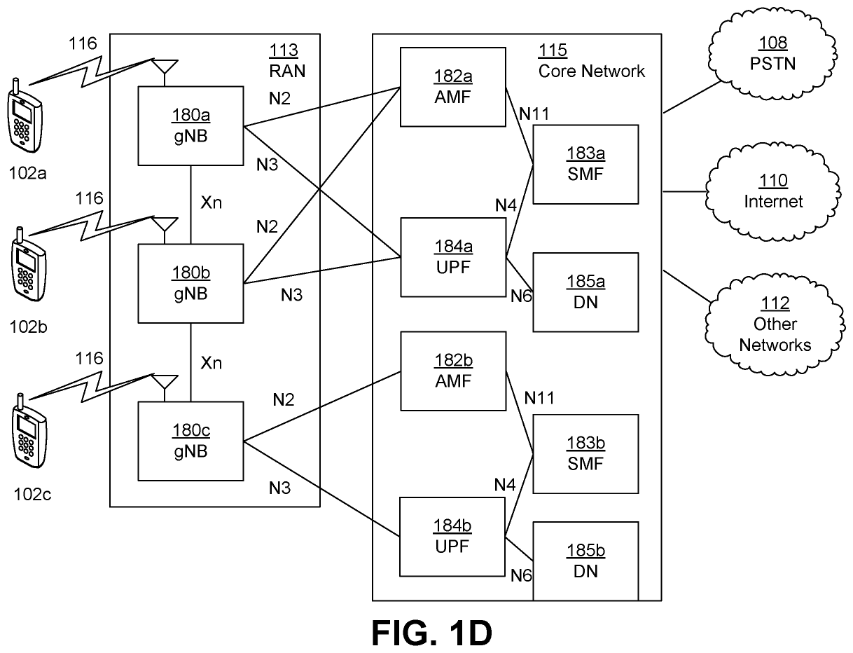

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A personal IoT network (PIN) may be a configured and/or managed group of PIN elements. Each PIN in the group may communicate with each other directly and/or via PIN elements with gateway capability (PEGC), able to communicate with 5G network via at least one PEGC, and/or managed by at least one PIN element with management capability (PEMC).

A PIN Element (PINE) may include a WTRU and/or a non-3GPP device. A PINE may communicate within a PIN (e.g., via PIN direct connection, PEGC, and/or PEGC and/or 5G core (5GC)), and/or outside the PIN via a PEGC and/or 5GC.

A PEGC may be a PIN element with the ability to provide connectivity to and/or from the 5G network for other PIN elements. The PEGC may provide relay for the communication between PIN elements.

A PEMC may be a PIN Element with capability to manage the PIN.

PINE-to-PINE communication may include communication between two PINES, including, but not limited to PINE-to-PINE direct communication and/or PINE-to-PINE indirect connection.

PINE-to-PINE direct connection may be the connection between two PIN elements without PEGC, any 3GPP RAN, and/or core network entity in the middle.

PINE-to-PINE indirect connection may be the connection between two PIN elements via PEGC and/or via the user plane function (UPF).

PINE-to-PINE routing may include routing traffic by a PEGC between two PINEs. These two PINEs may have a direct connection with the PEGC via non-3GPP access.

PINE-to-Network routing may occur when a PEGC routes traffic between PINE and 5G system (5GS). The PINE may direct connect with the PEGC via non-3GPP access separately.

Network local switch for PIN may occur when UPF(s) between two PINEs route the traffic. The two PINEs direct connect with two PEGCs via non-3GPP access separately.

As described herein, functionality described as part of a PINE may be implemented in a PIN client; functionality described as part of a PEGC may be implemented in a PIN gateway client; and/or functionality described as part of a PEMC may be implemented in a PIN management client.

Other functions of a PINE may perform functionality described as part of a PIN client. Other functions of a PEGC may perform functionality described as part of a PIN gateway client. Other functions of a PEMC may perform functionality described as part of a PIN management client.

Traffic rules (e.g., URSP rules) for the PIN may be extended with one or more additional parameters and/or the PIN ID to determine the PIN. The one or more additional parameters may include connection capabilities (e.g., “ims”, “mms”, and/or “internet”), an application descriptor (e.g., Android identifier (OSId) and/or Android application identifier (OSAPPId)), and/or a DNN.

Traffic descriptor determination rules for the PIN may be configured with the admin user via GUI, provided to PEGC via PEMC and/or directly configured in PEGC.

The traffic descriptor determination rules for the PIN may include PINE associations to connection capabilities, application descriptor, DNN, PIN-ID, and/or application differentiation. Application differentiation is included in case multiple applications running on PINEs may be achieved via mapping information on the port numbers with specific applications running on PINEs.

Traffic descriptor determination rules for the PIN may be provided by the 5G network (H-PCF) via NAS signaling to the PEGC and/or PEMC provided by the PIN server via UP to PEMC and/or PEGC.

The 5G network may provide traffic rules as PIN specific URSP rules. The network may provide list(s) of UPSIs associated with PIN ID and/or PLMN ID. These UPSIs may map to the policy section containing URSP rules.

For every newly detected application a WTRU may evaluate the URSP rules in the order of rule precedence. The WTRU may determine if the application matches the traffic descriptor of any URSP rule. When a WTRU determines that a URSP rule applies for a given application, the WTRU may select a route selection descriptor (RSD) within this URSP rule in the order of the RSD precedence.

When a WTRU finds a valid RSD, the WTRU may determine if there exists a PDU session that matches all components in the selected RSD. When a matching PDU session exists, the WTRU may associate the application to the existing PDU session (e.g., the WTRU may route the traffic of the detected application on this PDU session). If none of the existing PDU sessions match the RSD, the WTRU may try to establish a new PDU session using the values specified by the selected RSD.

If the RSD include a non-seamless offload indication, then the WTRU may attempt to use a WLAN access network to transmit the data outside of any PDU session. WLAN selection policy (SP) rules may be used to select the WLAN access network.

When traffic from an application is associated with a PDU session, an event may cause the WTRU to re-evaluate the URSP rules and/or associate the traffic from the application with a different PDU session. Examples of events that may trigger URSP re-evaluation include but are not limited to: an implementation dependent re-evaluation timer and/or the WTRU establishing access to a Wi-Fi network that provides internet access without using the 5GS (e.g., non-seamless offload becomes possible).

A traffic descriptor may be an application descriptor, an internet protocol (IP) descriptor, a domain descriptor, a non-IP descriptor, a data network name (DNN), and/or connection capabilities. An IP descriptor may be a destination IP 3 tuple(s) (e.g., a IP address and/or a IPv6 network prefix, a port number, and/or a protocol ID of the protocol above IP).

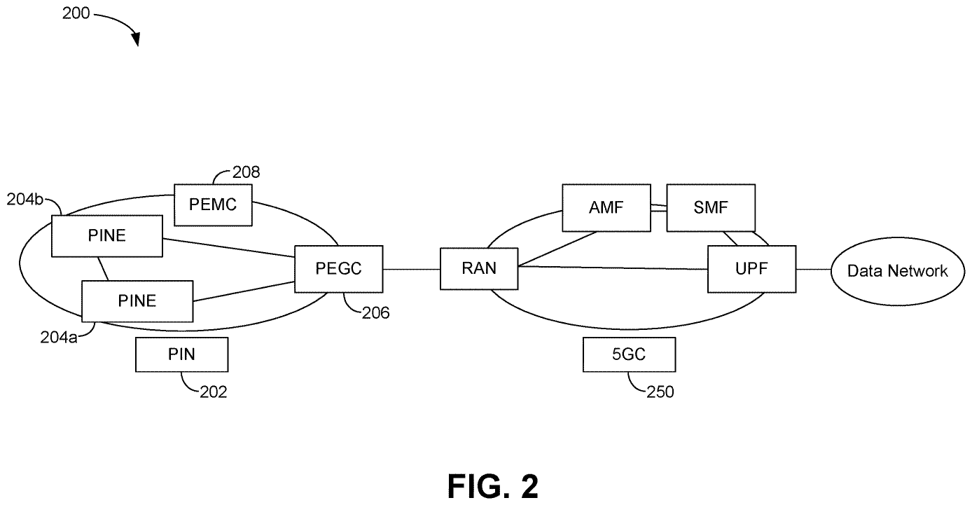

FIG. 2 is a diagram depicting an example personal Internet of Things (PIN) networks architecture. As seen in FIG. 2, a PIN 200 is a configured and/or managed group of PIN elements 204a, 204b. Each PIN 200 in the group may communicate with each other directly and/or via PEGC 206. The PIN 202 may communicate with 5G network via at least one PEGC 206 and/or be managed by at least one PEMC 208. PINE 204a, 204b are WTRU and/or non-3GPP device that may communicate within a PIN 202 (e.g., via PIN direct connection, via PEGC 206, or via PEGC 206 and/or 5GC 250), and/or outside the PIN (e.g., via a PEGC 206 and/or 5GC 250). A PEGC 206 is a PINE with the ability to provide connectivity to and/or from the 5G network for other PINEs 204a, 204b, and/or to provide relay for the communication between PINEs 204a, 204b. A PEMC 208 is a PINE with capability to manage the PIN 202. The 5G system may consist of radio access network (RAN) and/or 5G core network elements such as access and mobility management function (AMF), session management function (SMF), user plane function (UPF). The control plane signaling between the WTRU and/or network may occur between the WTRU and the AMF and/or between the AMF and/or the SMF. The user plane signaling between the WTRU and/or network is routed via the UPF entity of the 5G core network. The RAN may handle the radio interface (e.g., next generation radio access network (NG-RAN)).

Existing PINs may make one or many architectural assumptions. For example, a 3GPP WTRU may act as PEGC and/or PEMC. A PIN may comprise one or more PEGCs. A PIN may comprise one or more PEMCs, and/or, at any time any one of the PEMCs may control the PIN. The PINEs assume to use non-3GPP access (e.g., WIFI and/or Bluetooth) for direct communication. The PEMC may use ProSe (e.g., 5G ProSe) Direct Communication for direct communication with PEGC. The PEGC and/or PEMC may belong to the same PLMN, non-public network (NPN), and/or standalone non-public network (SNPN). A single PEGC may support more than one PIN at a time. A PEGC may support multi-hop P2P (e.g., communication between a chain of PINEs) and/or P2N relay (e.g., communication from a PINE to another PINE and/or to the network via an intermediate PINE).

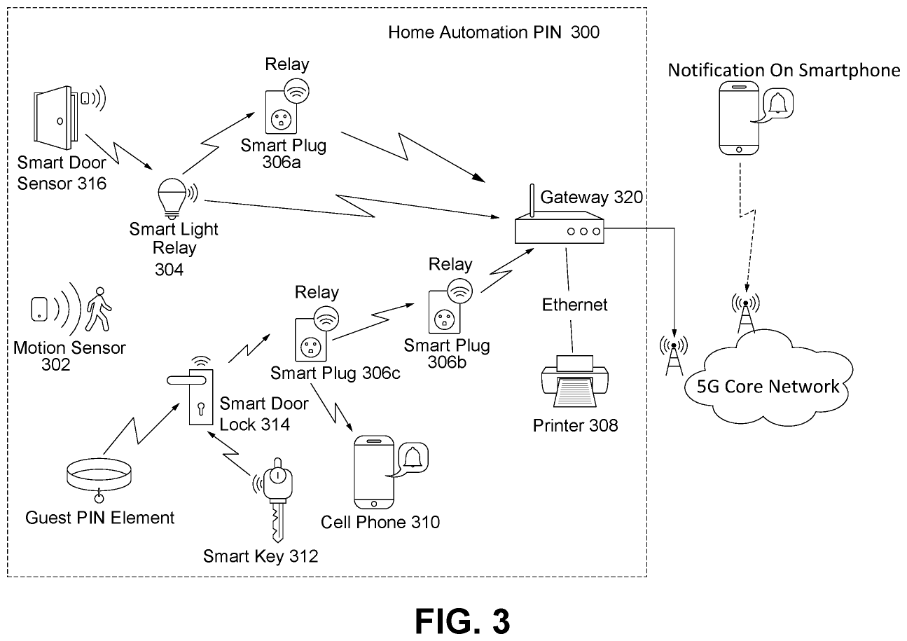

FIG. 3 is a diagram depicting an example home automation PIN 300. As seen in FIG. 3, the Internet of Things (IoT) feature has been designed for devices that may communicate using the traditional cellular network. Devices with IoT capabilities may require better power consuming performance and/or increased the network efficiency for bulk operations.

When multiple IoT devices are deployed in a private environment, the WTRUs with IoT capabilities can be organized in a personal IoT network (PIN) 300. For example, in a home environment, a residential gateway 310 may manage devices such as motion sensor 302, smart light relay 304, smart plug 306a, 306b, 306c, printer 308, cellphone 310, smart key 312, smart door lock 314, smart door sensor 316, and/or, etc. These devices may communicate with each other. In this case, all devices in the home constitute a PIN. Each device is called a PIN element (PINE) and different PINEs have different capabilities. For example, the residential gateway 320 may have PIN element with gateway capability (PEGC) to provide connections between PINEs and/or connections between 5G network and/or PINEs. A PIN element with management capability (PEMC) is a PINE that may allow an authorized administrator to configure and/or manage a PIN. The residential gateway 320, which acts as a PEGC, may support PIN management function as well. Further, the residential gateway may act as a PEMC.

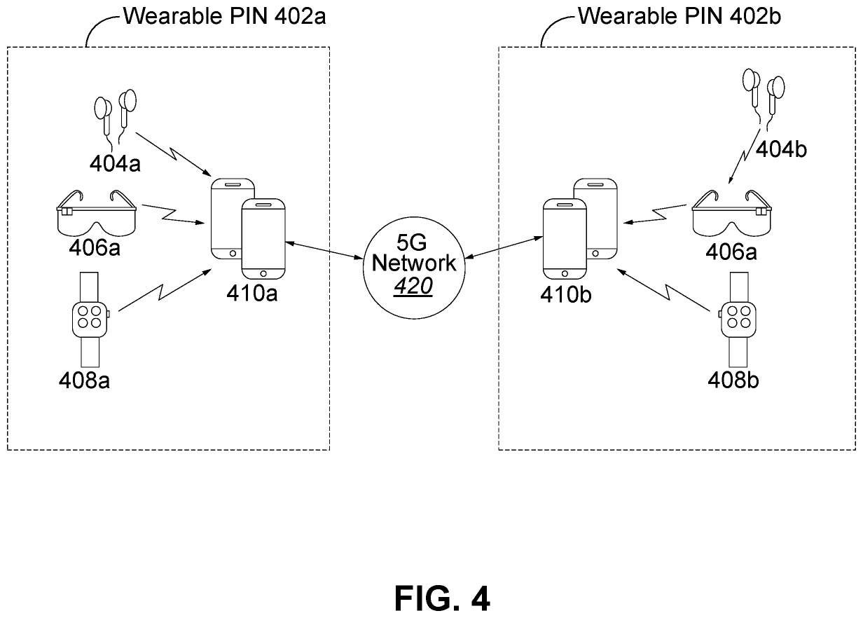

FIG. 4 is a diagram depicting an example wearable PIN. As seen in FIG. 4, multiple wearable devices (e.g., airpods 404a, 404b; VR/AR glasses 406a, 406b; and/or smart watches 408a, 408b) may also constitute another kind of PIN, e.g. a wearable PIN 402a, 402b. In this type of PIN, a smart phone 408a, 408b may act as, e.g., a PEGC and/or a PEMC. For example, the airpods 404a, VR/AR glasses 406a, and/or smart watches 408a, may communicate with each other in the PIN 402a. The airpods 404b may communicate directly with other PINEs, e.g., VR/AR glasses 406b within the PIN 402b. For example, the airpods 406b may use a Bluetooth connection to communicate with other PINEs. The PIN 402a may communicate with a PIN 402b via 5G network 420.

A PIN may also support application layer protocols. The PIN may be based on a PIN application layer functional model.

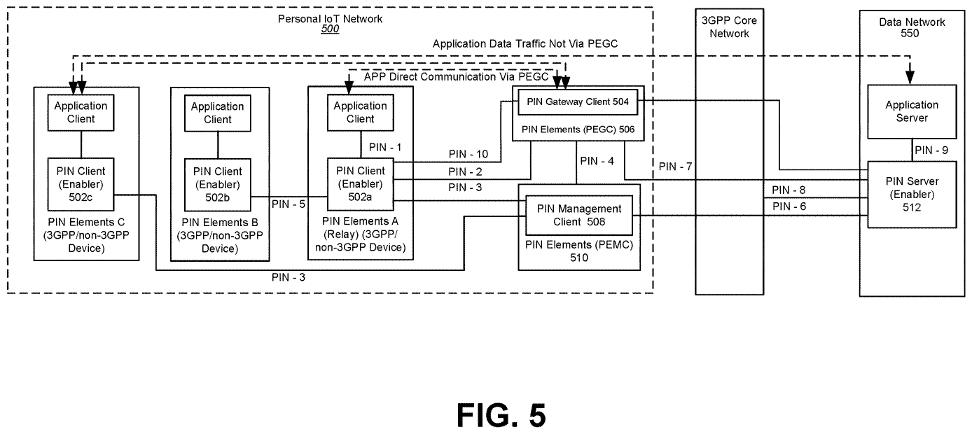

An example application architecture for enabling application layer support for personal internet of things (IoT) network (PINAPP) 500 is depicted in FIG. 5. Application entities such as PIN clients 502a, 502b, 502c in PINEs, PIN gateway clients 504 in PEGCs 506, PIN management clients 508 in PEMCs 510, and/or PIN servers 512 in data networks 550 are part of the PINAPP 500 architecture. These application entities may enable the desired features in a PIN. Herein described is how these entities and/or the PIN node function to enable PINAPP 500 features.

Establishment of multiple PDU sessions at a PEGC 506 per PIN may cause problems. The PEGC 506 may provide connectivity to and/or from the network (e.g., the 5G network) and/or one or more PINEs. The PEGC 506 may support multiple PDU sessions per PIN whereas the traffic differentiation may not support this functionality.

A PEGC 506 may route traffic from PINE to data networks 550. The PEGC 506 uses a PDU session to route traffic to and from a data network. The data network that PEGC 506 sends traffic to is determined by the PEGC 506 based on the characteristics of the traffic. Characteristics of the traffic may include any combination of the source address of the traffic, the destination address of the traffic, the source device (e.g., PINE ID) of the traffic, and/or the type of traffic (e.g., internet protocol multimedia subsystem (IMS), IoT sensor reading, streaming media).

A traffic in a PIN may have different characteristics. The PEGC may need to route traffic from a PIN may need to different data networks based on the characteristics. A PEGC may need to establish multiple PDU sessions to carry traffic from a PIN.

It may be desirable for a PEGC to determine what PDU session should be used to send uplink data from the PEGC when the PEGC is capable of sending uplink data from a PIN to different data networks. In other words, there needs to be a way to segregate traffic based on the desired service type. For example, IMS traffic from the PIN may need to go to an IMS PDU session associated with a first DNN/single network slice selection assistance information (S-NSSAI) combination. Internet traffic from the same PIN may need to go to an internet PDU session associated with a second DNN/S-NSSAI combination.

When the PEGC receives traffic from a PINE, the PEGC may determine if the traffic should be routed to another PINE and/or to a data network via a PDU Session.

Mechanisms and/or enhancements for the scenarios where PEGC supports different kinds of uplink traffic originating from PINEs are provided herein. Additional examples describing how that traffic is accordingly matched to different PDU sessions at the PEGC may be provided herein.

Enhancements to the URSP framework may be provided herein. The enhancements may be specific for the case where the URSP rule is used to route traffic associated with a PIN. The enhancements may extend the traffic descriptor to better account for the characteristics of the traffic and/or accordingly match the traffic to different PDU sessions at PEGC.

The policy control function (PCF) may send the PEGC one or more policy sections that include URSP rules that apply to PINs. In other words, the PEGC may receive URSP rules not specific to any PIN in policy sections separate from the policy sections that apply to the PIN. The PCF may send a mapping table to the PEGC. The PEGC may use the mapping table to determine which policy sections are associated with each PIN. When the PEGC detects uplink traffic associated with a PIN, the PEGC may check which policy sections are linked to the PIN ID in the mapping table. The PEGC may use these URSP rules to determine a PDU session to route the uplink traffic. For example, the URSP rules may indicate how to route the uplink traffic (e.g., PIN traffic) based on one or more PIN IDs and/or at least one traffic descriptor. In other words, the mapping table may indicate an association between PIN ID(s) and policy section identifiers.

The PEGC may be configured with one or more traffic descriptor determination rules. The one or more traffic descriptor determination rules may provide information about mapping PIN traffic to a traffic descriptor. The PEMC may receive one or more traffic descriptor determination rules. Additionally or alternatively, the one or more traffic descriptor determination rules may be received from the network (e.g., via NAS signaling). Additionally or alternatively, the one or more traffic descriptor determination rules may be received from a PIN Server via application layer signaling. Additionally or alternatively, the one or more traffic descriptor determination rules may be configured by an application hosted on the PEGC (e.g., a GUI and/or a PEGC client).

The PEGC may receive one or more URSP rules. A traffic descriptor part of the one or more URSP rules may include a PIN ID and/or one or more of a connection capability, a PINE ID, a source IP Address, a source port number, a fully qualified domain name (FQDN), a DNN, a destination IP Address, a destination port number, an OS identifier, and/or an application identifier.

The PEGC may receive uplink traffic that is associated with the PIN. The uplink data may have originated from a PINE. The uplink data may have originated from a PEGC client.

The PEGC may determine a traffic descriptor that is associated with uplink traffic. The PEGC may use one or more of the traffic descriptor determination rules to determine the traffic descriptor associated with the uplink traffic. The PEGC may determine a PIN ID associated with the uplink traffic. The PEGC may use both the PIN ID and the traffic descriptor to evaluate URSP rules.

The PEGC may determine one or more PDU session characteristics based on the URSP rule evaluation. If the PEGC has an already established PDU session that matches the one or more PDU session characteristics, the PEGC may use the PDU session to send the uplink traffic to the network.

Alternatively, if the PEGC does not have an already established PDU session that matches the one or more PDU session characteristics, the PEGC may send a PDU session establishment request to the network. The PDU session establishment request may include the one or more PDU session characteristics. The PEGC may then use the PDU session to send the uplink traffic to the network.

The PEGC may receive one or more URSP rule(s) in a policy section and/or an information element that includes a mapping table. The mapping table may indicate which PIN ID(s) are associated with the policy section. The mapping table may also include a PLMN ID that indicates that the URSP rules may apply for the PIN traffic when the PEGC is registered in the PLMN.

The PEGC may use the one or more traffic descriptor determination rules to determine a traffic descriptor associated with the uplink traffic the PEGC may determine a PIN ID and/or mapping table to determine URSP rule(s) that apply to the uplink traffic. The PEGC may use both the URSP rules and/or traffic descriptors to evaluate the determined URSP Rules. URSP rule evaluation may result in determination of PDU session characteristics.

The PEGC may be the PINE with the ability to provide connectivity to and from the 5G network for other PINEs. The PEGC may provide a relay for the communication between PINEs. One or more PINEs may use the PDU session established by the PEGC for the uplink (UL) data traffic to the external data network. A PIN element (PINE) may have different traffic requirements. Accordingly, it may not be appropriate for the traffic originating from all PINEs to be mapped to the same PDU session. Traffic differentiation may be performed at the PEGC level, for example, by routing different traffic via different PDU sessions.

For traffic differentiation, the traffic descriptor part of the URSP rule for the PIN may be extended to include a PIN ID and/or one or more additional parameters such as a connection capabilities indication, an application descriptor, a DNN, a destination address, a source address, and/or a source device identifier (e.g. a PINE ID). The PEGC may use the combination of PINE ID and/or at least one other parameter in the traffic descriptor to determine what URSP rule to apply to the traffic.

A PEGC may determine one or more traffic descriptor components of the uplink traffic originating from the applications running on the PINE. The PEGC may use one or more traffic descriptor determination rules to determine the one or more traffic descriptor components of uplink PIN traffic. The one or more traffic descriptor determination rules may be different means. For example, the PEGC may have traffic descriptor determination rule(s) (e.g., rules to determine a traffic description for the PIN traffic) that are configured via a GUI; configured via a message received from a PEMC; provided by the H-PCF (e.g., via the NAS signaling); and/or configured by the PEGC client (e.g., the PEGC client configures the traffic rules based on information from a PINE and/or from the PIN server).

One or more traffic descriptor determination rules may associate a traffic descriptor with uplink traffic. In some systems, traffic descriptor determination rules may not be supported. For example, in those systems, an application may provide a traffic descriptor (e.g., connection capabilities, DNN, and/or FQDN) to the mobile termination (MT) part of the WTRU. For example, in those systems, the MT part of the PEGC may determine the traffic descriptor based on the destination IP address and/or port number of the uplink traffic. The traffic descriptor may then be used in URSP rule evaluation. These approaches might not be suitable in cases where a PEGC needs to determine a traffic descriptor for uplink traffic that originates from a PINE and/or a PEGC client. A PINE may include a non-3GPP device that generates non-IP based traffic. Thus, a PINE may not provide a traffic descriptor to a PEGC and/or may not provide an IP address to the PEGC.

A WTRU (e.g., a PEGC) may use traffic descriptor determination rules to determine a traffic descriptor for uplink traffic that originates from a PINE and/or PEGC client. The traffic descriptor determination rules may be in the form of a table with an identifier and/or a traffic descriptor value.

The identifier in the traffic descriptor determination rule may be associated with the uplink traffic. The identifier may be a PINE ID that indicates that all traffic from the identified PINE is a match for the rule. The identifier may be a PINE client ID and/or a PEGC client ID that indicates that traffic (e.g., all traffic) from the identified client is a match for the rule. The identifier may be a PIN ID that indicates that traffic (e.g., all traffic) from the identified PIN is a match for the rule. The identifier may be a device type that indicates that traffic (e.g., all traffic) from a device of that type is a match for the rule. The identifier may be a location that indicates that traffic (e.g., all traffic) is a match for the rule when the PEGC is in the identified location. A combination of these identifier values may be used to identify traffic. For example, a combination of a PIN ID and/or a location may indicate traffic (e.g., all traffic) associated with a PINE. A client of the PIN may match when the PEGC is in the indicated location.

The traffic descriptor value in the traffic descriptor determination rule may indicate the traffic descriptor value to be associated with the identified traffic (e.g., associated with the identifier in the traffic descriptor determination rule). The traffic descriptor value may be an IP Address, a FQDN, a connection capabilities value, OSid, application ID, a descriptor for destination information of non-IP traffic, and/or a DNN.

When multiple applications are running on one or more PINEs, the one or more PINEs may communicate application ID(s) to the PEGC. For example, a PINE client may communicate a mapping of the port numbers to the specific application ID(s). Different PDU sessions may serve different applications running on the PINE. The PIN server may provide and/or configure this information to the PEGC.

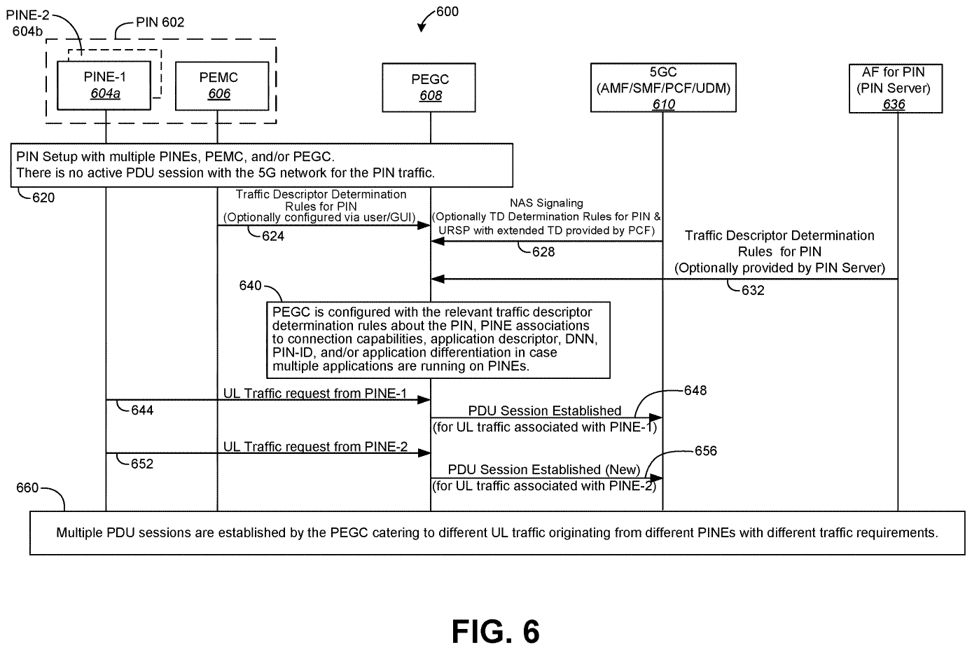

FIG. 6 is a call flow 600 depicting an example procedure for extension of traffic descriptor for PIN. At 620, a PIN 602 may be setup (e.g., successfully setup) with multiple PINEs 604a, 604b, a PEMC 606, and a PEGC 608. A PDU session may not have been established to send PIN traffic to a data network via the network 610 (e.g., 5GC, AMF, SMF, PCF, and/or user data management (UDM), all referred to as the network 610 in FIG. 6).

At 624, the PEGC 608 may receive one or more traffic descriptor determination rules. The PEMC 606 may provide the one or more traffic descriptor determination rules to the PEGC 608. Traffic configuration for PIN 602 may provide the information about the traffic originating from different PIN elements and/or may include PINEs 604a, 604b mapping to connection capabilities (e.g., internet protocol multimedia subsystem (IMS), multimedia subsystem (MMS), and/or an internet connection), application descriptor (OSId and/or OSAppId(s)), and/or DNN etc. For example, the one or more traffic descriptor determination rules received at 624 may indicate a mapping of uplink PIN traffic types to traffic descriptors. The PEGC 608 may use the traffic configuration to map the traffic originating from the PINEs to the corresponding PDU sessions established with the network (e.g., the 5G network). The PEGC 608 may consider URSPs provided by the network with an extended traffic descriptor section.

At 628, the home network 610 (e.g., PCF) may provide the one or more traffic descriptor determination rules to the PEGC 608 via NAS signaling. The network 610 (e.g., PCF) may also send, at 628, URSP rules to the PIN 602.

At 632, the PIN Server 636 (e.g., application function (AF) for PIN) may provide the one or more traffic descriptor determination rules to the PEGC 608 via the user plane. An already established PDU may be used by the PEGC 608 to receive the one or more traffic descriptor determination rules.

At 640, a GUI and/or a PEGC client may configure the one or more traffic descriptor determination rules. As described herein, the one or more traffic descriptor determination rules may include relevant traffic configuration information about the PIN, PINE associations to connection capabilities, application descriptors, DNNs, and/or PIN-ID, etc. The one or more traffic descriptor determination rules may describe how to differentiate between applications in scenarios where multiple applications are running on the same PINE. The differentiation may be achieved via mapping information based on the port numbers (e.g., source and/or destination port numbers for uplink/downlink (UL/DL) traffic, respectively) used by specific applications running on the PINEs. The PEGC 608 may have the URSP rules provided by the network 610 (e.g., PCF) for the traffic mapping to the PDU session. When the traffic descriptor is determined, the PEGC may use the traffic descriptor and/or URSP rules to determine what PDU session to use and/or what characteristics of a PDU session to establish.

At 644, UL traffic may be sent from the PINE-1 602 to the PEGC 608. Additionally or alternatively, the uplink traffic may originate from an application within the PEGC 608 (e.g., a PEGC client).

The PEGC 608 may evaluate the UL traffic from the PINE-1 602. Evaluating the UL traffic may include using the one or more traffic descriptor determination rules to determine a traffic descriptor associated with the UL traffic and/or using the PIN ID and/or the traffic descriptor to determine the characteristics (e.g., DNN, S-NSSAI, and/or service and session continuity (SSC) mode) of a PDU session for carrying the UL traffic. The PEGC 608 may select a PDU session for sending the uplink PIN traffic based on evaluation of the USRP rules using the PIN ID and the determined traffic descriptor.

At 648, if the PEGC 608 has already established a PDU session that matches the determined characteristics (e.g., DNN, S-NSSAI, and/or SSC mode), the PEGC 608 may use the already established PDU session to send the uplink traffic. Alternatively, if the PEGC 608 determines that there is no existing PDU session which matches the determined characteristics (e.g., DNN, S-NSSAI, and/or SSC mode), the PEGC 608 may use the determined characteristics to trigger establishment of a new PDU session with the network. Further, the PEGC 608 may associate the PINE-1 604a application uplink traffic to this new PDU session.

At 652, UL traffic may be sent from the PINE-2 604b to the PEGC 608. Additionally or alternatively, the uplink traffic may originate from an application within the PEGC 608 (e.g., a PEGC client). The originator of the U traffic may be different than the origin of the uplink traffic generated by the PINE-1 604a.

At 656, the PEGC 608 may evaluate the UL traffic from the PINE-2 604b by using the one or more traffic descriptor determination rules to determine a traffic descriptor associated with the UL traffic. The PEGC 608 may also use the PIN ID and/or the traffic descriptor to determine the characteristics (e.g., DNN, S-NSSAI, and/or SSC mode) of a PDU session for carrying the uplink traffic. The PEGC 608's evaluation of the one or more traffic descriptor determination rules may result in determining a different traffic descriptor than what was determined for the traffic from PINE-1 604a. A different traffic descriptor may be determined because the characteristics (e.g. source or destination IP address, traffic type, connection capabilities, DNN/S-NSSAI etc.) of the traffic received from PINE-2 604b may be different than the characteristics of the traffic received from PINE-1 604a. When the PEGC 608 uses the traffic descriptor determined, at 656, (e.g., a second traffic descriptor) to determine the characteristics (e.g., DNN, S-NSSAI, and/or SSC mode) of a PDU session for carrying the UL traffic received from the PINE-2 604b, the PEGC 608 may determine one or more characteristics that are different than the PDU session characteristics (e.g., second PDU session characteristics). These PDU session characteristics (e.g., second PDU session characteristics) may be determined based on the UL traffic received from PINE-1 604a (e.g., a second DNN, a second S-NSSAI, and/or a second SSC mode).

If the PEGC 608 has already established a PDU session that matches the second PDU session characteristics, the PEGC 608 may determine to use the already established PDU session to send the uplink traffic. If the PEGC 608 determines no PDU session exists which matches with the second PDU session characteristics, the PEGC 608 may use the determined characteristics (e.g., second DNN, second S-NSSAI, and/or second SSC mode) to trigger establishment of a new PDU session with the network. The PEGC 608 may associate the PINE-2 604b application UL traffic to this new PDU session.

At 660, the PEGC 608 may associate with multiple PDU sessions. Each PDU session may cater to different types of UL traffic originating from different PINEs 604a, 604b and/or applications with different traffic requirements.

The URSP provided by the network may include a list of PIN IDs (instead of a single PIN ID). The PIN IDs on the list may share the same traffic descriptor part. The PIN IDs may assist when multiple PINs share the same PDU session and/or are served by the same PEGC.

A PEGC may be a PIN element with the ability to provide connectivity to and/or from the network (e.g., 5G network) for other PINEs and/or to provide relay for the communication between PINEs. PINEs may use PDU sessions established by the PEGC for the sending and/or receiving data traffic to and/or from a data network. Each PINE may have different traffic requirements. As such, the traffic originating from all PINEs may not map to the same PDU sessions. Thus, traffic differentiation may be required at the PEGC level, for example, by routing different traffic via different PDU sessions.

The network (e.g., the H-PCF) may provision the PIN with one or more PIN specific URSP rules. The PIN specific URSP rules may provide the necessary traffic differentiation at the PEGC and/or PIN level. These PIN specific URSP rules may be provided to the PEGC at successful registration with the network and/or after the PEGC provides the PIN identifier to the network (e.g., as part of the registration request message).

Example triggers for the H-PCF to send PIN specific URSP rules to the PEGC may include one or more of the following: PIN specific URSP rules from the H-PCF may be sent to the PEGC in a NAS registration accept in response to the PEGC providing the PIN ID in the NAS registration request. PIN specific URSP rules from the H-PCF may be sent to the PEGC in a NAS WTRU configuration update message. The H-PCF may trigger the message upon a notification from the UDM and/or user data repository (UDR) that the PEGC's subscription has been updated and/or upon a request from an AF that manages the PIN. Additionally or alternatively, PIN specific URSP rules may be provided by the H-PCF using other NAS signaling messages and/or via steering of roaming (SoR).

The PIN specific URSP rules may be sent to the PEGC in a policy section without any URSP rules that are not PIN specific. The message used to send the PIN specific URSP rules to the PEGC may also include an information element that indicates which PIN ID(s) are associated with which policy section(s). The information element may indicate a mapping from PIN ID to UPSI. The PEGC may associate a PLMN ID with PIN specific URSP rules. The PLMN ID to associate with the PIN specific URSP rules may be HPLMN ID and/or the PLMN ID that the PEGC is registered to when the PIN specific URSP rules are received. Additionally or alternatively, the information element that carries the mapping information may include PLMN ID(s), PIN ID(s), and/or UPSI(s).

The PEGC may consider the PIN specific URSP rules to be valid while the PEGC is registered with an associated PLMN and/or its equivalent PLMNs. When the PEGC changes PLMNs, the PEGC may trigger to re-evaluate URSP rules. When the PEGC evaluates URSP rules and/or determines that no PIN specific URSP rule is associated with the PIN in the PEGC's current registered PLMN, the PEGC may determine to block any uplink traffic from the PIN. Blocking uplink traffic may indicate that no uplink PIN traffic is towards a PDU session. In roaming scenarios, the H-PCF provides this information via a visited policy control function (V-PCF).

As PIN is dynamic, with PIN elements joining and/or leaving the PIN. The PIN specific URSPs may be re-evaluated at each configuration change of the PIN (e.g., such as PINEs joining and/or leaving the PIN).

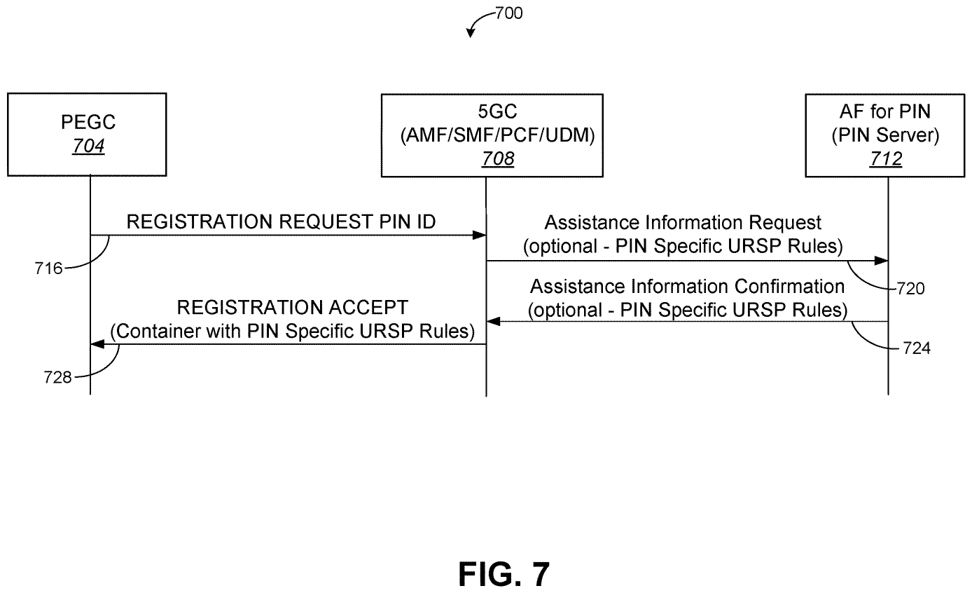

FIG. 7 is a call flow depicting an example procedure 700 for PIN specific URSP rules. FIG. 7 shows an example procedure where the PCF is triggered to send PIN specific URSP rules to the PEGC during a registration procedure. The PCF may also trigger a WTRU configuration update procedure and use the UE configuration update message to send the PIN specific URSP rules to the PEGC. The PCF may trigger the WTRU configuration update procedure because the PCF received updated service parameters from the UDM, UDR, and/or AF.

At 716, the PEGC 704 may trigger the registration request message (e.g., initial, mobility, and/or periodic) toward the network 708 (e.g., 5GC, AMF, SMF, PCF, and/or UDM) including the PIN ID. Additionally or alternatively, at 720, the network 708 may check with the PIN server 712 for the PIN specific URSP rules. Additionally or alternatively, at 724, the PIN server 712 may provide parameters that are used to create the PIN specific URSP rules to the network 708 via the network exposure function (NEF) interface. At 728, the network 708 may respond with the registration accept message and may include the policy container including PIN specific URSP rules provided by the network 708.

As described in the FIG. 6, the PEGC may be configured with the traffic descriptor determination rules. The PEGC may evaluate the UL traffic from the PIN elements. Evaluating the UL traffic may include using the traffic descriptor determination rules to determine a traffic descriptor associated with the UL traffic. Evaluating the UL traffic may also include using the PIN specific URSP rules provided by the network for matching the UL traffic to appropriate URSP rule. If the PEGC has already established a PDU session that matches the determined characteristics (e.g., DNN, S-NSSAI, and/or SSC mode), then the PEGC may determine to use the already established PDU session to send the uplink traffic. If the PEGC determines no PDU session exists which matches the determined characteristics (e.g., DNN, S-NSSAI, and SSC mode), then the PEGC may use the determined characteristics (e.g., DNN, S-NSSAI, and SSC mode) to trigger establishment of a new PDU session with the network. The PEGC may also associate the PINE-1 application uplink traffic to this new PDU session.

An additional data network may internally and/or externally route PIN traffic to the PIN. On reception of the traffic from the PINEs, the PEGC may determine if the traffic is intended for another PINE within the same PIN or meant for an external data network.

The PEGC may consider traffic (e.g., all traffic) to be subject to URSP rule evaluation. The URSP rules may indicate how to route uplink PIN traffic based on one or more identifiers and/or at least one traffic descriptor. The structure of the RSD within the URSP may be enhanced to indicate that the traffic that matches the Traffic Descriptor be internally routed to the PIN. The RSD may further indicate a destination address for the traffic (e.g., a destination IP address for another PINE within the PIN). The PCF may provide enhanced URSP to the PEGC. The AF for the PIN may assist the PCF via NEF with PIN traffic configuration (e.g., source and/or destination IP addresses for PINEs, PINE IDs, and/or updated RSDs, etc.).

Additionally or alternatively, the PEGC may be configured with rules that detect if traffic should be routed inside of the PIN (e.g., sent to another PINE within the PIN) or routed to a data network via a PDU session. One or more traffic descriptor determination rules may determine if traffic should be routed inside of the PIN (e.g., sent to another PINE within the PIN) and/or routed to a data network via a PDU session. For example, the traffic descriptor determination rules may indicate that a special traffic descriptor value is associated with the traffic. The presence of the special traffic descriptor value may indicate that traffic should be routed to another PINE within the PIN. The destination address of the traffic may be part of the traffic (e.g., an IP address), determined based on the content of the traffic descriptor determination rules, and/or determined based on implementation specific means. When the PEGC determines that the traffic should be routed to a data network via a PDU session, the PEGC may use URSP rule evaluation to determine what PDU session should carry the traffic.

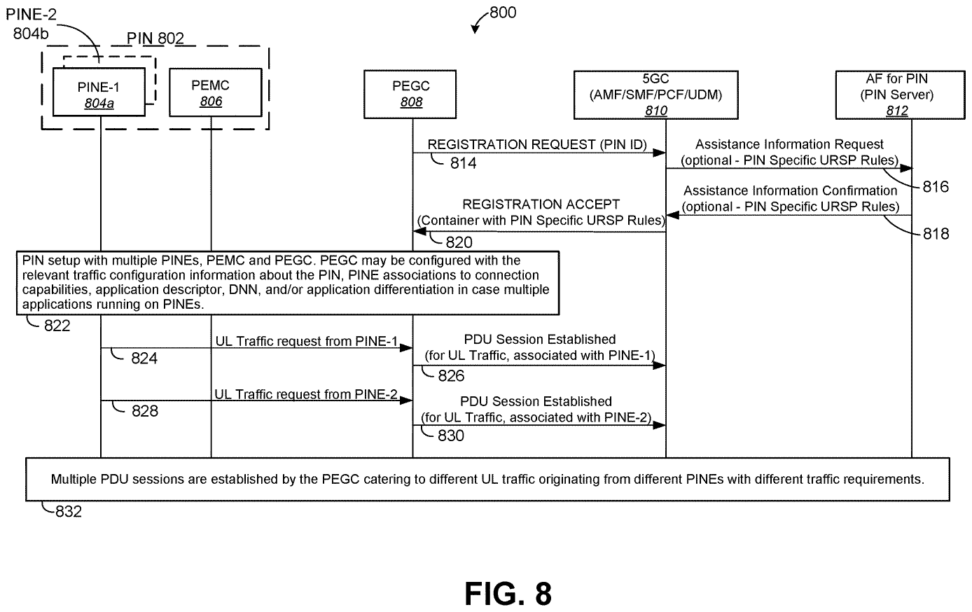

FIG. 8 is a call flow depicting an example procedure 800 for extension of traffic descriptor for PIN using PIN specific URSP rules. FIG. 8 depicts another example procedure where the PCF trigger and sends PIN specific URSP rules to the PEGC during a registration procedure. FIG. 8 further depicts how that procedure incorporates the PEGC and its configuration with the traffic descriptor determination rules.

At 814, the PEGC 808 may send a registration request message (e.g., initial, mobility, and/or periodic) toward the network 810 (e.g., the AMF, SMF, PCF, and/or UDM). At 816, the registration request message may include the PIN ID. The network 810 may check with the PIN server 812 for the PIN 802 specific URSP rules. At 818, the PIN server 812 may provide one or more parameters that may be used to create the PIN specific URSP rules to the network 810 via the NEF interface. At 820, the network 810 may respond to the registration request message with a registration accept message. The registration request message may include a policy container including PIN 802 specific URSP rules provided by the network 810.

At 822, the PIN 802 may be setup with multiple PINEs 804a, 804b, PEMC 806, and/or PEGC 808. The PEGC 808 may be configured with the relevant traffic descriptor determination rules about the PIN 802, PINEs 804a, 804b associations to connection capabilities, application descriptor, DNN, and/or application differentiation in case multiple applications running on PINEs 804a, 804b.

The PEGC 808 may have traffic descriptor determination rule(s) (e.g., rules to determine a traffic description for the PIN 802 traffic) configured via a message received from a PEMC 806.

The traffic descriptor determination rule(s) may be provided by the H-PCF, for example, via the NAS signaling.

The traffic descriptor determination rule(s) may be configured by the PEGC client. The PEGC client may configure the traffic descriptor determination rule(s) based on information from a PINE 804a, 804b and/or from the PIN server 812.

At 824, UL traffic may be sent from the PINE-1 804a to the PEGC 808. Additionally or alternatively, the uplink traffic may originate from an application within the PEGC 808 (e.g., a PEGC client).

At 826 the PEGC 808 may evaluate the UL traffic from the PINE-1. Evaluating the UL traffic may involve using the traffic descriptor determination rules to determine a traffic descriptor s associated with the UL traffic. Evaluating the UL traffic may also involve using the PIN ID and/or the traffic descriptor to determine the characteristics (e.g., DNN, S-NSSAI, and/or SSC mode) of a PDU session for carrying the UL traffic. If the PEGC 808 has already established a PDU session that matches the determined characteristics, the PEGC 808 may determine to use the already established PDU session to send the UL traffic. If the PEGC 808 determines no PDU session exists which matches with the determined characteristics, the PEGC 808 may use the determined characteristics to trigger establishment of a new PDU session with the network. Further, the PEGC 808 may associate the PINE-1 804a application UL traffic to this new PDU session.

At 828, UL traffic may be sent from the PINE-2 804b to the PEGC 808. Additionally or alternatively, the UL traffic may originate from an application within the PEGC 808 (e.g., a PEGC client). The originator of the UL traffic may be different than the origin of the UL traffic generated by the PINE-1 804a.

At 830, the PEGC 808 may evaluate the UL traffic from the PINE-2 804b by using the one or more traffic descriptor determination rules to determine a traffic descriptor associated with the UL traffic and/or using the PIN ID. Further, the PEGC 808 may evaluate the traffic descriptor to determine the characteristics (e.g., DNN, S-NSSAI, and/or SSC mode) of a PDU session for carrying the UL traffic. The PEGC 808's evaluation of the traffic descriptor determination rules may result in determining a different traffic descriptor than the traffic determined for the UL traffic from the PINE-1 804a.

The characteristics (e.g. source or destination IP address, traffic type, connection capabilities, and/or DNN/S-NSSAI etc.) of the traffic received from the PINE-2 804b may be different than the characterises of the traffic that was received from the PINE-1 804a. Thus, a different traffic descriptor may be determined. When the PEGC 808 uses the traffic descriptor determined for the UL traffic from the PINE-2 804b (e.g., a second traffic descriptor) to determine the characteristics (e.g., DNN, S-NSSAI, and SSC mode) of a PDU session for carrying the UL traffic received from the PINE-2 804b, the PEGC 808 may determine one or more characteristics (e.g., second PDU Session characteristics) different than the PDU session characteristics determined for the UL traffic received from the PINE-1 804a (e.g., a second DNN, a second S-NSSAI, and/or a second SSC mode).

If the PEGC 808 has already established a PDU session that matches the second PDU session characteristics, the PEGC 808 may determine to use the already established PDU session to send the uplink traffic. If the PEGC 808 determines no PDU session exists which matches with the second PDU session characteristics, the PEGC 808 may use the determined characteristics (e.g., a second DNN, a second S-NSSAI, and/or a second SSC mode) to trigger establishment of a new PDU session with the network 810. Further, the PEGC 808 may associate the PINE-2 804b application UL traffic to this new PDU session.

At 832, the PEGC 808 may associate with multiple PDU sessions. Each PDU session may cater to different types of UL traffic originating from different PINEs 804a, 804b and/or applications with different traffic requirements.

What is claimed is:

1.-20. (canceled)

21. A method implemented by a wireless transmit/receive unit (WTRU), the method comprising:
receiving traffic descriptor determination rules that indicate an association of personal internet of things network element (PINE) identifiers (IDs) to traffic descriptors;
receiving user equipment route selection policy (URSP) rules that indicate how to route uplink traffic from a PIN based on one or more PIN identifiers (IDs) and at least one of the traffic descriptors;
receiving uplink traffic from a PINE associated with a PIN ID of the one or more PIN IDs;
determining a traffic descriptor for the received uplink traffic from the PINE based on the received traffic descriptor determination rules and a PINE ID associated with the PINE;
selecting a protocol data unit (PDU) session associated with the determined traffic descriptor for sending the uplink traffic based on evaluation of the URSP rules using the PIN ID and the determined traffic descriptor; and
sending the received uplink traffic to the network via the selected PDU session.

22. The method of claim 21, wherein the traffic descriptor determination rules comprise an association between traffic identifiers and respective traffic descriptor values.

23. The method of claim 21, further comprising evaluating the USRP rules to determine one or more PDU session characteristics, wherein the PDU session for sending the uplink traffic from the PINE is selected based on the determined one or more PDU session characteristics matching the PDU session.

24. The method of claim 23, further comprising:
determining that no established PDU sessions match the determined one or more PDU session characteristics; and
triggering establishment of the selected PDU session based on the determination that no established PDU sessions match the determined one or more PDU session characteristics.

25. The method of claim 21, wherein the uplink traffic from the PINE originated from a PINE or an application hosted on the WTRU.

26. The method of claim 21, wherein the URSP rules are received from a PIN element with management capability (PEMC), the network, a PIN server, or an application hosted on the WTRU.

27. The method of claim 21, wherein the uplink traffic from the PINE types comprise one or more of internet protocol multimedia subsystem (IMS), internet of things (IoT) sensor reading, or streaming media.

28. The method of claim 21, wherein the traffic descriptors comprise one or more of a connection capability, a PINE ID, a source internet protocol (IP) address, a source port number, a fully qualified domain name (FQDN), a data network name (DNN), a destination IP address, a destination port number, an operating system (OS) identifier, or an application identifier.

29. The method of claim 21, further comprising sending a request to the network to establish the selected PDU session.

30. The method of claim 21, wherein the uplink traffic from the PINE is first uplink traffic from the PINE, the PIN ID is a first PIN ID, the traffic descriptor is a first traffic descriptor, and the selected PDU session is a first selected PDU session, the method further comprising:
receiving second uplink traffic from the PINE associated with a second PIN ID of the one or more PIN IDs;
determining a second traffic descriptor for the second uplink traffic from the PINE based on the received traffic descriptor determination rules;
selecting a second protocol data unit (PDU) session for sending the second uplink traffic from the PINE based on evaluation of the URSP rules using the second PIN ID and the second traffic descriptor; and
sending the second uplink traffic from the PINE to the network via the second selected PDU session.

31. A wireless transmit/receive unit (WTRU) comprising a processor, the processor configured to:
receive traffic descriptor determination rules that indicate an association of uplink personal internet of things network element (PINE) identifiers (IDs) to traffic descriptors;
receive user equipment route selection policy (URSP) rules that indicate how to route uplink traffic from the PIN based on one or more identifiers (IDs) and at least one of the traffic descriptors;
receive uplink traffic from a PINE associated with a PIN ID of the one or more PIN IDs;
determine a traffic descriptor for the received uplink traffic from a PINE based on the received traffic descriptor determination rules and a PINE ID associated with the PINE;
select a protocol data unit (PDU) session associated with the determined traffic descriptor for sending the uplink traffic based on evaluation of the URSP rules using the PIN ID and the determined traffic descriptor; and
send the received uplink traffic to the network via the selected PDU session.

32. The WTRU of claim 31, wherein the traffic descriptor determination rules comprise an association between traffic identifiers and respective traffic descriptor values.

33. The WTRU of claim 31, the processor further configured to evaluate the USRP rules to determine one or more PDU session characteristics, wherein the PDU session for sending the uplink traffic from the PINE is selected based on the determined one or more PDU session characteristics matching the PDU session.

34. The WTRU of claim 33, the processor further configured to:
determine that no established PDU sessions match the determined one or more PDU session characteristics; and
trigger establishment of the selected PDU session based on the determination that no established PDU sessions match the determined one or more PDU session characteristics.

35. The WTRU of claim 31, wherein the uplink traffic from the PINE originated from PINE or an application hosted on the WTRU.

36. The WTRU of claim 31, wherein the URSP rules are received from a PIN element with management capability (PEMC), the network, a PIN server, or an application hosted on the WTRU.

37. The WTRU of claim 31, wherein the uplink traffic from the PINE types comprise one or more of internet protocol multimedia subsystem (IMS), internet of things (IoT) sensor reading, or streaming media.

38. The WTRU of claim 31, wherein the traffic descriptors comprise one or more of a connection capability, a PINE ID, a source internet protocol (IP) address, a source port number, a fully qualified domain name (FQDN), a data network name (DNN), a destination IP address, a destination port number, an operating system (OS) identifier, or an application identifier.

39. The WTRU of claim 31, the processor further configured to send a request to the network to establish the selected PDU session.

40. The WTRU of claim 31, wherein the uplink traffic from the PINE is first uplink traffic from the PINE, the PIN ID is a first PIN ID, the traffic descriptor is a first traffic descriptor, and the selected PDU session is a first selected PDU session, and the processor is further configured to:
receive second uplink traffic from the PINE associated with a second PIN ID of the one or more PIN IDs;
determine a second traffic descriptor for the second uplink traffic from the PINE based on the received traffic descriptor determination rules;
select a second protocol data unit (PDU) session for sending the second uplink traffic from the PINE based on evaluation of the URSP rules using the second PIN ID and the second traffic descriptor; and
send the second uplink traffic from the PINE to the network via the second selected PDU session.
